(19) United States
(12) Patent Application Publication
(10) Pub. No.: US 2010/0230869 A1
(43) Pub. Date: Sep. 16, 2010

(54) VACUUM PRESS MACHINE AND VACUUM PRESS METHOD

(75) Inventor: Shizuaki Okazaki, Fuchu-shi (JP)

Correspondence Address: DAY PITNEY LLP, 7 TIMES SQUARE, NEW YORK, NY, 10036-7311, US

(73) Assignee: KITAGAWA SEIKI KABUSHIKI KAISHA, Fuchu-shi (JP)

(21) Appl. No.: 12/721,609

(22) Filed: Mar. 11, 2010

(30) Foreign Application Priority Data
Mar. 12, 2009 (JP) 2009-059378

(51) Int. Cl. B29C 51/10

(52) U.S. Cl. 264/571; 425/388

(57) ABSTRACT

A vacuum press machine includes a platen on which a workpiece is placed, an elastic release sheet provided above the workpiece, a frame arranged above the platen and movable toward and away from the platen. The frame urges the release sheet toward the platen with the workpiece therebetween so that a first space, which is air-tightly closed, is formed between the release sheet and the platen when the frame is moved to contact the platen. A portion of the release sheet covering the workpiece presses the workpiece as the first space is vacuumed. After the pressing, the frame is moved away from the platen, and a release sheet conveying mechanism introduces an unused portion of the release sheet to between the platen and the frame, and discharges the used portion of the release sheet from between the platen and the frame.

### CROSS-REFERENCE TO RELATED APPLICATION

This application claims priority under 35 U.S.C. §119 from Japanese Patent Application No. 2009-59378 filed on Mar. 12, 2009. The entire subject matter of the application is incorporated herein by reference.

### BACKGROUND

1. Technical Field

The following description relates to a vacuum press machine and a vacuum press method for pressing a workpiece by placing the workpiece in a space, at least a part of which is defined by an elastic diaphragm, and vacuuming the space so that the workpiece is pressed by the diaphragm.

2. Prior Art

Conventionally, vacuum press machines employing an elastic diaphragm as disclosed in Japanese Patent Provisional Publication No. HEI 10-641 have been used for stacking sheet-like or film-like layers to form workpieces. Typically, such a vacuum press machine has a pair of platens, one or both of which is provided with elastic diaphragm(s). The workpieces are placed between the pair of platens and pressed thereby. If the elastic diaphragm is provided to only one of the platens, when the pair of platens are moved relative to each other, the other platen, to which the elastic diaphragm is not provided, and the elastic diaphragm closely contact directly or through a gasket to form a closed (i.e., air-tight) space with the workpiece therebetween. If both the platens are provided with the diaphragms, when the pair of platens approach relative to each other, the elastic diaphragms are closely contacted with each other to form the closed (i.e., air-tight) space with the workpiece therebetween.

In such a vacuum press machine, a workpiece is placed in the closed space formed as above. A vacuum pump is provided to communicate with the space. As the vacuum pump is actuated to vacuum the space, the elastic diaphragm(s) deforms to press the workpiece placed in the closed space. If the workpiece is to be heat-pressed, a heater is provided to the platen(s) so that the space is vacuumed with applying heat to the workpiece.

The vacuum press machines, in particular, ones for heat-press are configured to operate such that tension and heat are applied to the diaphragm(s) every time a pressing operation is performed. Therefore, the diaphragms are deteriorated in a relatively short period of time and the elasticity thereof may change. When the elasticity of the diaphragm is changed, load applied by the diaphragm to the workpiece when the pressing operation is performed varies. As above, in the conventional vacuum press machines, as the pressing operations are repeated, deterioration of the elastic diaphragms proceeds. Therefore, in the conventional vacuum press machine, pressing with a stable press condition cannot be expected.

### SUMMARY OF THE INVENTION

At an area of the diaphragm, which area contacts an edge portion of the workpiece, concentrated load is applied. Therefore, at such an area, deterioration proceeds quicker than the other areas. If a workpiece having a rough (i.e., convexo-concave) surface, portions of the diaphragm that contacts edge portions of the workpiece are applied with the concentrated load and are likely deteriorated quickly. As above, after repeatedly performing pressing operations, the diaphragm has deteriorated portions and less deteriorated portions. As a result, with such deteriorated diaphragms, there occurs a problem that load cannot be evenly applied to the workpiece.

In consideration of the above problem, the present invention is advantageous in that a pressing machine and pressing method that enable application of even and stable pressing force is provided.

According to an aspect of the invention, there is provided a vacuum press machine which is provided with a platen on which a workpiece is placed, an elastic release sheet provided above the workpiece, a frame arranged above the platen and configured to movable toward and away from the platen, the frame urging the release sheet toward the platen with the workpiece therebetween so that a first space which is air-tightly closed is formed between the release sheet and the platen with the workpiece being sandwiched therebetween when the frame is moved to contact the platen, a vacuum pump communicating with the first space and configured to vacuum the first space, a portion of the release sheet covering the workpiece pressing the workpiece as the first space is vacuumed, a driving mechanism configured to move the frame relative to the platen, and a release sheet conveying mechanism configured to introduce an unused portion of the release sheet to between the platen and the frame and discharge the used portion of the release sheet from between the platen and the frame after the workpiece is pressed and molded.

According to another aspect of the invention, there is provided a method of applying a vacuum press to a workpiece by vacuuming a first space defined between a release sheet and a platen to press-mold the workpiece placed in the first space, which includes a first step of conveying, with use of a conveying mechanism, the workpiece onto the platen, and feeding, with use of a release sheet feeding system, an unused portion of the release sheet to an area where the platen and frame face each other, a second step of moving the frame relative to the platen so that the frame approaches the platen to make the frame urge the release sheet, between the frame and the platen, so that the release sheet cover the workpiece and form the first space, a third step of vacuuming the first space so that the workpiece is press-molded, a fourth step of moving the frame relative to the platen so that the frame separates from the platen to make the release sheet removed from the workpiece, and a fifth step of discharging, with use of a release sheet moving system, a used portion of the release sheet from the area between the frame and the platen.

### BRIEF DESCRIPTION OF THE ACCOMPANYING DRAWINGS

FIG. 1 schematically shows a configuration of a vacuum press machine according to an embodiment of the invention.

FIGS. 2A and 2B show cross-sectional views of frames and platens contacting each other, a space defined by a diaphragm and a platen being not vacuumed (FIG. 2A) and being vacuumed (FIG. 2B).

FIG. 3 shows a flowchart illustrating a press operation for pressing a workpiece.

### DETAILED DESCRIPTION OF EMBODIMENT

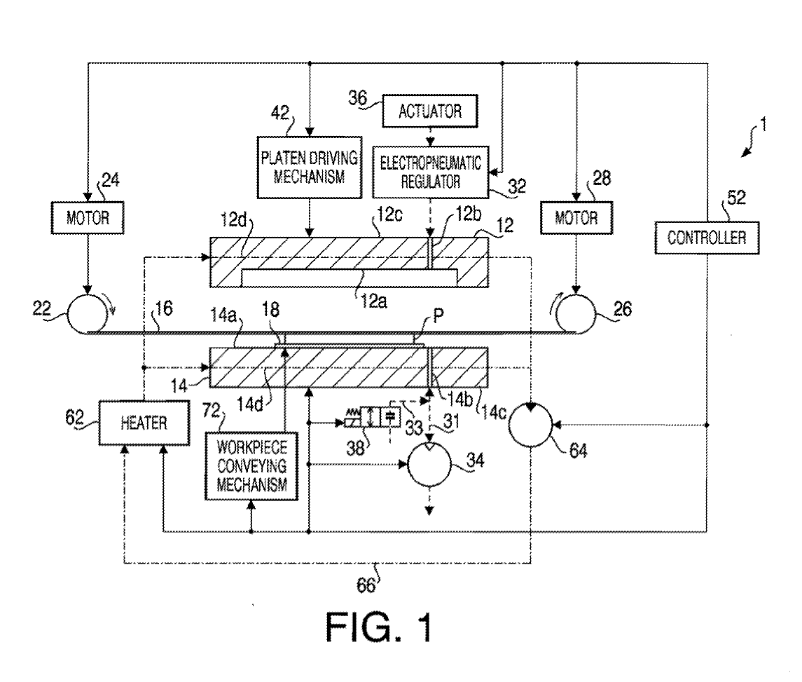

FIG. 1 schematically shows a configuration of a vacuum press machine 1 according to an embodiment. As shown in FIG. 1, the vacuum press machine 1 has a frame 12 and a platen 14, which are arranged along the up and down direction. The frame 12 is driven to move in an up/down direction (i.e., moving toward/away from the frame 14) using a platen driving mechanism 42 which includes a hydraulic cylinder mechanism or the like. The platen driving mechanism 42 operates under control of a controller 52.

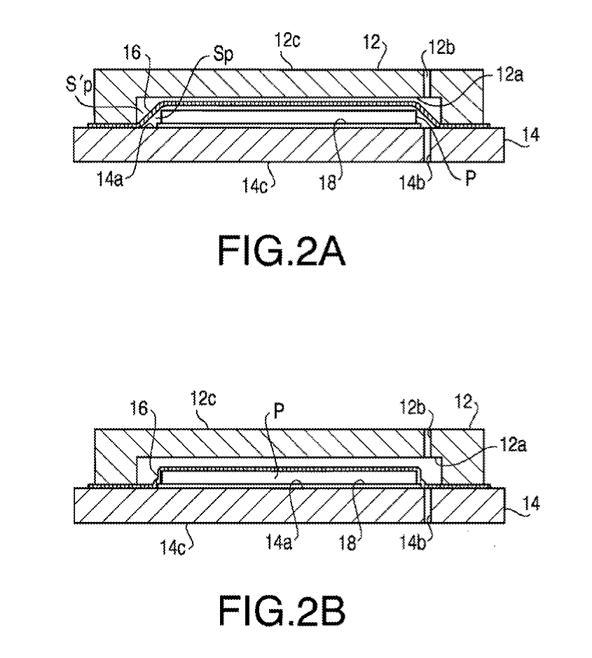

The workpiece P to be pressed by the vacuum press machine 1 is placed on the platen 14 via a lower release sheet 18. The frame 12 is a plate-like member having a recess 12a on a lower surface thereof. When the frame 12 is moved close to the platen 14 using the platen driving mechanism 42, the workpiece P and the lower release sheet 18 are accommodated inside the recess 12a as shown in FIG. 2A.

Between the frame 12 and the platen 14, an upper release sheet 16 is arranged. The upper release sheet 16 is a heat-resistive elastic sheet which is formed of silicon-rubber or the like. When the frame 12 is moved to closely contact the platen 14, the upper release sheet 16 is nipped between the frame 12 and the platen 14 as shown in FIG. 2A. In this state, the upper release sheet 16 closely contacts both the frame 12 and the platen 14.

When the frame 12 is driven to closely contact the platen 14 with the workpiece P being placed above the platen 14, the workpiece P and the lower release sheet 18 are accommodated inside the frame 12 (see FIG. 2A). At this stage, the upper portion of the workpiece P is covered with the upper release sheet 16, while the upper release sheet 16 is sandwiched between the frame 12 and the platen 14 on the side portions with respect to the workpiece P. As shown in FIG. 2A, at this state, a first space Sp (see FIG. 2A), which is defined by an upper surface 14a of the platen 14 and the upper release sheet 16 (see FIG. 2A), and a second space Sp′, which is defined by the lower surface 12a of the frame 12 and the upper release sheet 16, are formed. As shown in FIG. 2A, the workpiece P and the lower release sheet 18 are accommodated in the first space Sp.

As shown in FIG. 1, both ends of the upper release sheet 16 are taken up by a reeling 22 and unreeling 26, which are arranged on both sides of the frame 12 and the platen 14, respectively. The reeling 22 and the unreeling 26 are connected to motors 24 and 28, respectively. By driving the motors 24 and 28 so that the upper release sheet 16 is fed from the unreeling 26 and taken up by the reeling 22, the upper release sheet 16 is conveyed from the unreeling 26 to the reeling 22. The motors 24 and 28 are controlled by the controller 52. By adjusting the rotation speed of the motors 24 and 28 with the controller 52, a desired tension can be applied to the release sheet 16 which is located between the frame 12 and the platen 14.

The platen 14 is formed with a through hole 14b communicating from the lower surface 14c to the upper surface 14a as shown in FIGS. 1, 2A and 2B. Further, as shown in FIG. 1, a vacuum pump 34 is connected to an opening of the through hole 14b on the lower surface 14c of the platen 14. The vacuum pump 34 is also controlled by the controller 52. By actuating the vacuum pump 34 when the upper release sheet 16 is nipped between the frame 12 and the platen 14 to form the first space Sp (see FIG. 2A), the first space Sp can be vacuumed.

Further, as schematically shown in FIG. 1, a branching duct 33 is provided to an air duct 31 at a position between the through hole 14b and the vacuum pump 34. An electromagnetic valve 38 is implemented to the branching duct 33. The controller 52 controls the electromagnetic valve 38 to open/close the branching duct 33. When the first space Sp is to be vacuumed, the controller 52 controls the electromagnetic valve 38 to close the branching duct 33. When the vacuumed state of the first space Sp is to be released, the controller 52 controls the electromagnetic valve 38 to open the branching duct 33 so that the air outside the press machine 1 is introduced in the first space Sp.

The frame 12 is formed with a through hole 12b which communicates the upper surface 12c and the lower surface 12a of the frame 12. As shown in FIG. 1, an electropneumatic regulator 32 is connected to an opening of the through hole 12b on the upper surface 12c. The electropneumatic regulator 32 is controlled by the controller 52 to function to maintain a delivery pressure at substantially 1 atm (i.e., 1013.25 hPa). Therefore, when the release sheet 16 is nipped between the frame 12 and the platen 14, the pressure inside the second space Sp′ is maintained at substantially 1 atm. It should be noted that, since the delivery pressure of the electropneumatic regulator 32 is lower than the inlet pressure, it is necessary to maintain the inlet pressure at more than 1 atm in order to maintain the delivery pressure at substantially 1 atm. For this purpose, an actuator 36 is provided at an inlet of the electropneumatic regulator 32.

According to the embodiment, in order to heat-press the workpiece P, the frame 12 and the platen 14 are heated. A configuration for heating the frame 12 and the platen 14 will be described hereinafter.

Inside the frame 12 and the platen 14, as shown in FIG. 1, heat medium paths 12d and 14d are formed. At inlets and outlets of the head medium paths 12d and 14d, a duct 66 is connected. In mid-course positions of the duct 66, a heater 62 and a heat medium circulation pump 64 are provided, respectively (see FIG. 1). The heater 62 functions to heat the heat medium inside the duct 66 to a desired temperature. When the heat medium circulation pump 64 is actuated, the heat medium is circulated inside the duct 66 and the heat medium paths 12d and 14d. Therefore, by driving the heater 62 and the heat medium circulation pump 64, the heat medium, which is heated up to the desired temperature, is circulated within a heat medium circulation path that includes the heat medium paths 12d and 14d. With the heat medium circulating the heat medium paths 12d and 14d, the frame 12 and the platen 14 are heated and maintained to have the desired temperature. Although not shown for brevity, the heat medium paths 12d and 14d are arranged to wind inside the frame 12 and the platen 14 so that, as the heat medium is circulated by the heat medium circulation pump 64, the frame 12 and the platen 14 are heated to have the substantially constant temperature. It should be noted that the heater 62 and the heat medium circulation pump 64 are also controlled by the controller 52.

The press machine 1 is provided with a workpiece conveying mechanism 72, which has a belt conveyer, configured to introduce the workpiece P that has not been processed from the outside of the machine 1 and locate the introduced workpiece P between the platen 14 and the upper release sheet 16, and to convey the workpiece P that has been processed (i.e., pressed) from between the platen 14 and the upper release sheet 16 to the outside of the press machine 1. The workpiece conveying mechanism 72 is also controlled by the controller 52.

Next, a method of press-molding the workpiece P executed by the vacuum press machine 1 according to the embodiment will be described.

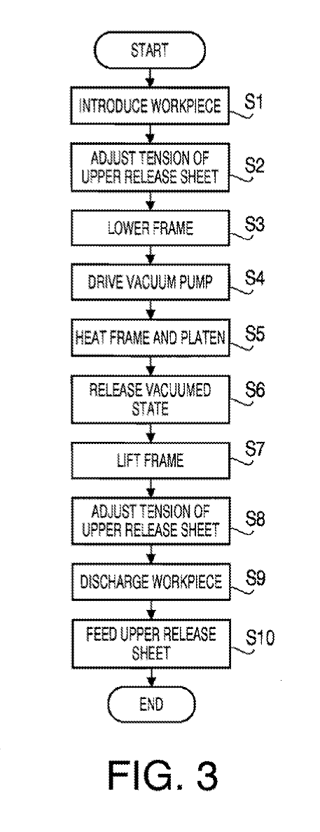

FIG. 3 is a flowchart illustrating the method of press-molding a workpiece P.

Firstly, the controller 52 controls the workpiece conveying mechanism 72 to convey the workpiece P that has not yet pressed and placed on the lower release sheet 18 to the platen 14 and locate the workpiece P on the platen with the release sheet 18 being sandwiched between the workpiece and the platen 14 (S1). Then, the controller 52 drives the motors 24 and 28 to adjust the tension of the upper release sheet 16, and stops the motors 24 and 28 to hold the tension of the upper release sheet 16 (S2).

Next, the controller 52 drives the platen drive mechanism 42 to lower the frame 12 so that the upper release sheet 16 is sandwiched between the frame 12 and the platen 14 (S3). With this control, the first space Sp is defined between the upper surface 14a of the platen 14 and the upper release sheet 16, and the lower release sheet 18 and the workpiece P are arranged in the first space Sp, as shown in FIG. 2A.

Then, the controller 52 drives the vacuum pump 34 to vacuum the first space Sp (S4). As mentioned above, the pressure inside the second space Sp′ (see FIG. 2A) which is above the upper release sheet 16, is retained to substantially 1 atm. Therefore, there is a pressure difference between a portion above and a portion below the upper release sheet 16. Due to this pressure difference, the upper release sheet 16 is press contacted to the workpiece P as shown in FIG. 2B.

According to the embodiment, as described above, the upper release sheet 16 is sandwiched between the frame 12 and the platen 14 with the tension applied thereto. Therefore, the first space Sp is formed without loosening of the upper release sheet 16 between the frame 12 and the platen 14. Then, when the first space Sp is vacuumed in such a state, wrinkles are not formed on the upper release sheet 16 and the workpiece P is pressed evenly by the upper release sheet 16. Further, since the controller 52 controls the motors 24 and 28 so that the tension applied to the release sheet 16 is substantially constant, the workpiece P can be pressed under the stable pressing condition.

Next, the controller 52 drives the heater 62 and the heat medium circulation pump 64 in order to heat the frame 12 and the platen 14 (S5). Thus, the workpiece P is heat-pressed.

After the workpiece P has been sufficiently heat-pressed, the controller 52 stops the vacuum pump 34, the heater 62 and the heat medium circulation pump 64. Further, the controller 52 opens the electromagnetic valve 38 to restore the pressure in the first space Sp to the air pressure (S6). Then, the controller 52 controls the platen drive mechanism 42 to elevate the frame 12 (S7), and controls the motors 24 and 28 to increase the tension applied to the upper release sheet 16. Then, the upper release sheet 16 is separated (removed) from the workpiece P.

Next, the controller 52 controls the workpiece conveying mechanism 72 to conveys the workpiece P, which has been pressed, and the lower release sheet 18 from between the frame 12 and the platen 14 (S9). Then, the controller 52 controls the motors 24 and 28 to feed the upper release sheet 16 from the unreeling 26 to the reeling 22 (S10). By repeating the process from S1 to S10, the workpieces P are pressed.

According to the vacuum press machine 1, as describe above, after the press of the workpiece P has been completed, a portion of the upper release sheet 16 which portion is used for pressing the workpiece P is taken up by the reeling 22, and unused portion of the upper release sheet 16 is drawn from the unreeling 26. Therefore, pressing of the workpiece P is always performed using the unused portion of the upper release sheet 16 (i.e., a portion which is not deteriorated is used for pressing). That is, according to the embodiment, pressing is always performed under the stable condition.

According to the above-described exemplary embodiment, the frame 12 and the platen 14 are heated by circulating the heat medium which is heated outside the press machine 1 in the frame 12 and the platen 14. The present invention needs not be limited to such a configuration and various modification can be made without departing from the scope of the invention. For example, the frame 12 and the platen 14 may be heated with respectively provided cartridge heaters. For another embodiment, only one of the frame 12 and the platen 14 may be heated if the workpiece P can be heated sufficiently.

According to the above-described exemplary embodiment, the frame 12 is moved with respect to the platen 14 which is not moved. However, the invention needs not be limited to such a configuration, and the platen 14 may be moved instead of or in addition to the frame 12.

Further, according to the above-described embodiment, after the first space Sp is vacuumed, the frame 12 and the platen 14 are heated. However, it is only an exemplary embodiment, and can be modified such that the frame and/or the platen 14 may be heated when the first space Sp is being vacuumed.

What is claimed is:

1. A vacuum press machine, comprising:
a platen on which a workpiece is placed;
an elastic release sheet provided above the workpiece;
a frame arranged above the platen and configured to movable toward and away from the platen, the frame urging the release sheet toward the platen with the workpiece therebetween so that a first space which is air-tightly closed is formed between the release sheet and the platen with the workpiece being sandwiched therebetween when the frame is moved to contact the platen;
a vacuum pump communicating with the first space and configured to vacuum the first space, a portion of the release sheet covering the workpiece pressing the workpiece as the first space is vacuumed;
a driving mechanism configured to move the frame relative to the platen; and
a release sheet conveying mechanism configured to introduce an unused portion of the release sheet to between the platen and the frame and discharge the used portion of the release sheet from between the platen and the frame after the workpiece is pressed and molded.

2. The vacuum press machine according to claim 1, further comprising a tension adjusting system configured to adjust the tension of the release sheet at the area between the frame and the platen.

3. The vacuum press machine according to claim 1, further comprising:
a reeling and an unreeling provided on both sides of an area between the frame and the platen, respectively, both ends of the release sheet being wounded by the reeling and the unreeling, respectively; and
a driving system configured to drive the reeling to take up the used portion of the release sheet located between the frame and the platen, and the unreeling to feed the unused portion of the release sheet to the area between the frame and the platen.

4. The vacuum press machine according to claim 3, further comprising a tension adjusting system configured to adjust the tension of the release sheet at the area between the frame and the platen.

5. The vacuum press machine according to claim 4, wherein the tension adjusting system adjusts the tension of the release sheet by; controlling a rotation speed of the reeling and a rotation speed of the unreeling.

6. The vacuum press machine according to claim 1,
wherein the frame is a plate-like member formed with a recess that accommodates the first space when the frame urges the release sheet against the platen, and
wherein the vacuum press machine further comprises a pressure maintaining system configured to maintain the pressure of a second space which is surrounded by the recess and the release sheet at substantially one atm.

7. The vacuum press machine according to claim 1, further comprising a heater configured to heat at least one of the frame and the platen.

8. The vacuum press machine according to claim 1, further comprising a workpiece conveying mechanism configured to introduce a workpiece which has not been molded to the area between the frame and the platen, and to discharge a workpiece which has been molded from the area between the frame and the platen.

9. A method of applying a vacuum press to a workpiece by vacuuming a first space defined between a release sheet and a platen to press-mold the workpiece placed in the first space, comprising:
a first step of conveying, with use of a conveying mechanism, the workpiece onto the platen, and feeding, with use of a release sheet feeding system, an unused portion of the release sheet to an area where the platen and frame face each other;
a second step of moving the frame relative to the platen so that the frame approaches the platen to make the frame urge the release sheet, between the frame and the platen, so that the release sheet cover the workpiece and form the first space;
a third step of vacuuming the first space so that the workpiece is press-molded;
a fourth step of moving the frame relative to the platen so that the frame separates from the platen to make the release sheet removed from the workpiece; and
a fifth step of discharging, with use of a release sheet moving system, a used portion of the release sheet from the area between the frame and the platen.

10. The method according to claim 9,
wherein the first step includes a step of applying a desired tension to the release sheet by controlling the release sheet feeding system when the release sheet is fed.

11. The method according to claim 9,
wherein the third step includes a step of maintaining a pressure of a second space formed between the frame and the release sheet to a predetermined pressure in order to generate a pressure difference between above and below areas of the release sheet when the first space is vacuumed.

12. The method according to claim 1, further comprising a step of heating at lease one of the frame and the platen when the first through third steps is performed.
